(19) United States
(12) Patent Application Publication
(10) Pub. No.: US 2016/0131563 A1
(43) Pub. Date: May 12, 2016

(54) PRESSURE-PULSATED FATIGUE TEST AND SPECIMEN DESIGN

(71) Applicants: SCOTT F. SHAFER, MORTON, IL (US); ALAN W. WELLS, NORTH FORT MYERS, IL (US); MARK S. ELLISON, CHILLICOTHE, IL (US); LIFENG WANG, DUNLAP, IL (US)

(72) Inventors: SCOTT F. SHAFER, MORTON, IL (US); ALAN W. WELLS, NORTH FORT MYERS, IL (US); MARK S. ELLISON, CHILLICOTHE, IL (US); LIFENG WANG, DUNLAP, IL (US)

(21) Appl. No.: 14/535,421

(22) Filed: Nov. 7, 2014

(51) Int. Cl. G01N 3/36; F02M 65/00; G01M 7/08

(52) U.S. Cl. CPC G01N 3/36; G01M 7/08; F02M 65/00

(57) ABSTRACT

A method to test for fatigue in a test sample is disclosed. The method includes providing a specimen as the test sample. The specimen has a shoulder portion, a tubular sidewall that defines a bore, and an undercut wall segment. The sidewall includes a first thickness, which is greater than a second thickness of undercut wall segment. The method further includes providing a fixture that includes an insert and a clamp to retain the specimen, positioning the bore of the specimen substantially about the insert, and retaining the shoulder portion of the specimen by use of the clamp. Next, the method includes generating a cyclic loading within the bore by hydraulic pulsation between a first predetermined pressure and a second predetermined pressure, at a predetermined frequency. The test is carried through by maintaining and recording the cyclic loading until the specimen fails by fracture of the undercut wall segment.

### TECHNICAL FIELD

The present disclosure relates generally to a method to test fatigue in fuel system components. More specifically, the present disclosure relates to the use of a specimen of the components being subject to cyclic loading.

### BACKGROUND

Components used in high-pressure diesel fuel injection systems, such as fuel injection valves, may be subject to cyclic loading and relatively high stresses that act from the inside-out of the components. Accordingly, such components are required to be made of materials that exhibit effective material characteristics and reliable design to withstand fatigue and extreme operational conditions.

Traditional methods for the determination of high-cycle fatigue properties in such components include a uniaxial tensile test and high-speed rotating beam test. However, the state of stress created by such methods may only limitedly apply to the states of stresses prevalent in actual high-pressure fuel systems. This is because components of a fuel system are generally exposed to high-cyclic loading, which creates a biaxial state of stress in both a relative hoop and axial direction. Moreover, traditional test methods offer limited capability in evaluating substantially subtle effects that may be monitored for the overall performance of such components. Subtle effects typically include process-imparted compressive residual stresses, surface finishing, finish levels, surface flaw sizes, and non-uniform microstructure effects, such as carburization, hardening, and/or nitriding.

U.S. Pat. No. 7,921,708 discloses a method to prepare at least one of a test specimen or a test assembly to be used in a durability test that uses an engine block. Although this reference discloses a test specimen and a method to perform a durability test, no solution exists to test specimens, for example, from the inside-out, which may be the actual state of stresses prevalent in high-pressure fuel systems.

Accordingly, the system and method of the present disclosure solves one or more problems set forth above and/or other problems in the art.

### SUMMARY OF THE INVENTION

Various aspects of the present disclosure illustrate a method to test for fatigue in a test sample. The method includes provision of a specimen as the test sample. The specimen includes a shoulder portion, a tubular sidewall that defines a bore, and the tubular sidewall that includes an undercut wall segment. The sidewall has a first thickness and the undercut wall segment has a second thickness. The first thickness may be greater than the second thickness. The method further includes a provision of a fixture with an insert and a clamp. The insert and the clamp may retain the specimen within the fixture. Then, the bore of the specimen is positioned substantially about the insert. Thereafter, the shoulder portion of the specimen is retained by use of the clamp. Next, a generation of a cyclic loading within the bore by hydraulic pulsation is applied to the bore of the specimen between a first predetermined pressure and a second predetermined pressure, at a predetermined frequency. By maintaining the cyclic loading until a failure of the specimen, and recording the plurality of cyclic loading until failure, the test is carried through. A failure of the specimen occurs by a fracture of the undercut wall segment.

### BRIEF DESCRIPTION OF THE DRAWINGS

FIG. 1 is a cross-section of a specimen-fixture assembly applied in a pressure-pulsated fatigue test system, in accordance with the concepts of the present disclosure;

FIG. 2 is an isometric top view of the specimen-fixture assembly of FIG. 1, in accordance to the concepts of the present disclosure;

FIG. 3 is a view of exemplary test equipment applied in a pressure-pulsated fatigue test system, in accordance with the concepts of the present disclosure; and

FIG. 4 is a flowchart that illustrates an exemplary method of the pressure-pulsated fatigue test system of FIG. 3, in accordance with the concepts of the present disclosure.

### DETAILED DESCRIPTION

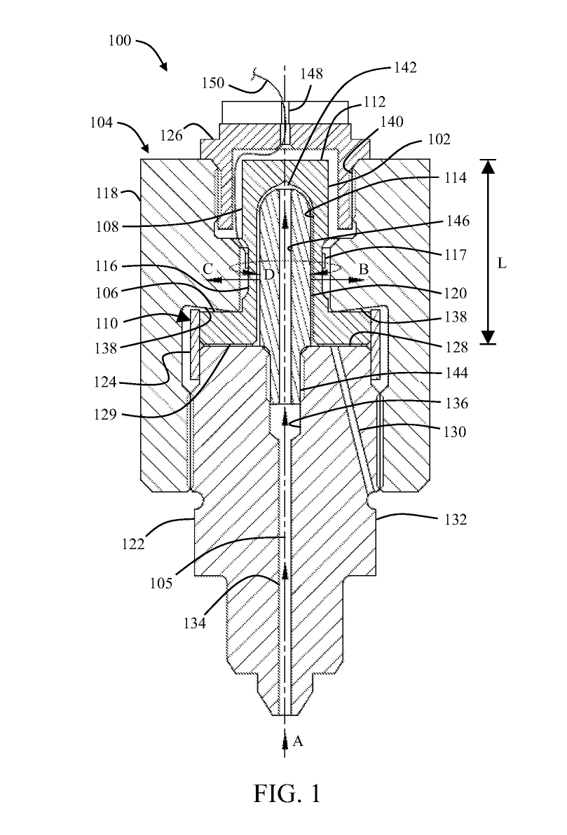

Referring to FIG. 1, there is shown a cross-section of a specimen-fixture assembly 100 applied in an exemplary pressure-pulsated fatigue test system, according to the present disclosure. A related test process may examine the durability and reliability of components of a fuel injection system applied in internal combustion engines. Internal combustion engines may include compression ignition engines that undergo relatively high stresses during operation. Other engine types may be contemplated. Notably, references and an application of the present disclosure may extend to machines, such as off-highway trucks, scrapers, motor graders, large mining trucks (LMTs), articulated trucks, asphalt pavers, tracked machines, and/or the like. Machines may embody at least one of a wheeled or a tracked configuration and may be associated with mining, agriculture, forestry, construction, and other industrial applications. An extension of an application of the present disclosure may be envisioned for machines, such as generators, employed in domestic and commercial establishments. An application may also extend to machines that are applicable for daily use.

The specimen-fixture assembly 100 includes a specimen 102 and a fixture 104. The specimen 102 serves as the test sample, while the fixture 104 accommodates the specimen 102 during an associated test process. The accommodation of the specimen 102 relative to the fixture 104 may be such that the specimen 102 is fixedly attached and is immovable relative to the fixture 104, during the test process. The specimen-fixture assembly 100 includes an axis 105, as illustrated.

The specimen 102 may be a thimble-shaped structure that may be subject to the stresses sustained by one or more components of an exemplary fuel injection system (not shown), during the test process. The specimen 102 may include an elongation length, L, as shown. More particularly, the specimen 102 may include a shoulder portion 106 and a tubular sidewall 108. The shoulder portion 106 may be structured and arranged at a specimen end 110 of the tubular sidewall 108. Structurally, the shoulder portion 106 may encompass and be co-axially aligned with the tubular sidewall 108, as shown. A resultant profile of the specimen 102 may include a relatively smaller diameter associated with the tubular sidewall 108 and a relatively larger diameter of the shoulder portion 106. However, along the elongation length, L, of the specimen 102, the tubular sidewall 108 may be longer than the shoulder portion 106. Further, a specimen head 112 lies opposite to the specimen end 110, as shown. Although the structure disclosed above, the noted configurations may be viewed as being purely exemplary in nature.

The tubular sidewall 108 may define a bore 114 extending through the shoulder portion 106. The resultant structure may impart a thickness to the tubular sidewall 108, which may be referred to as a first thickness. Although not limited, the first thickness may generally be about 2.5 millimeters (mm) but may range from about 0.5 mm to 5.0 mm.

Further, the tubular sidewall 108 may include an undercut wall segment 116. The undercut wall segment 116 may include a second thickness, which may be less than the first thickness (of the tubular sidewall 108). This relatively thin section of the specimen 102 is subject to a fatigue-induced failure during the test process. As an example, a thickness of the undercut wall segment 116 may be 1.1 mm or about 44 percent of the first thickness, although the undercut wall segment 116 may include a different thickness value characteristic to the requirements of an associated test process. For example, the second thickness may range from about 30 percent to about 60 percent of the first thickness. In an embodiment, the thickness of the undercut wall segment 116 may be non-uniform. Moreover, a strain gauge 117 (described later) may be connected to the undercut wall segment 116 to facilitate determination of the strain sustained by the undercut wall segment 116, during a related test process. This may further facilitate derivation of the stress acting in the region by known equations.

The bore 114 provides access to an inside of the specimen 102. This allows pressure to be applied to the interior of the specimen 102 and the resulting stresses provided from the inside-out during the test. In an embodiment, the bore 114 may be coated on the inside with one or more characteristic materials, applicable to the actual components of fuel injection systems. As a result, an associated reliability of the coating may also be determined during the test.

The specimen 102 may be manufactured by machining a commercial bar stock or by suitable casting methods. Materials to manufacture the specimen 102 may be selected from a wide variety of materials available depending upon the ultimate intended purpose. The material selected may be of the same kind as used in actual fuel injection application. When other material types are applied, known equations may be employed to determine a thickness value or ratio that should exist between the first thickness and the second thickness.

The fixture 104 may include a clamp 118, an insert 120, and an adapter 122. The clamp 118 may be mounted to the adapter 122. The fixture 104 may further include a sleeve 124 and a cap 126. The sleeve 124 generally helps position the specimen 102 stably relative to the fixture 104, while the cap 126 restricts the specimen 102 within the fixture 104, irrespective of a failure.

The adapter 122 may be substantially a cylindrical-shaped unit with an upper face 128, as shown. The upper face 128 may be diametrically congruent with the shoulder portion 106 of the specimen 102. During an exemplary test process assembly, therefore, the upper face 128 may abut and be circumferentially flush with the shoulder portion 106. When assembled, the adapter 122 and the specimen 102 may define an abutting interface 129 and be co-axially aligned along the axis 105. A drain 130 may extend from the upper face 128 to an adapter sidewall 132. The drain 130 may be configured to purge a fluid that may seep into a clearance existing between the upper face 128 and the shoulder portion 106 of the specimen 102, during the test process. The drain 130 also provides a visual indication and diagnostics of any undesired leakage between the specimen 102 and upper face 128. The adapter 122 may include an adapter channel 134, which linearly extends through the adapter 122. The adapter channel 134 may include a widened profile towards the upper face 128, to define an insert-receiving portion 136. The insert-receiving portion 136 facilitates a receipt and attachment of the insert 120 to the adapter 122.

The clamp 118 may be a cylindrically-shaped unit that substantially encompasses the upper face 128 when in engagement with the adapter 122. Although not limited, a related engagement may be threadably secured. As with the assembly of the specimen 102 relative to the adapter 122, the clamp 118 may be co-axially aligned to the adapter 122 along the axis 105, as well. When assembled, the clamp 118 may provide sufficient clearance to facilitate accommodation of the specimen 102 as an interface between the adapter 122 and the clamp 118. Effectively, the specimen 102 may occupy a region between the clamp 118 and the adapter 122, as shown. The clamp 118 includes a clamp wedge 138, which may engage and press the shoulder portion 106 of the specimen 102 versus the upper face 128, thereby fixedly securing the specimen 102 within the fixture 104, during a test process. In so doing, the clamp 118 may at least cylindrically encompass the specimen 102. However, the specimen head 112 may remain uncovered by the clamp 118 via a clamp outlet 140 when assembled. That structural aspect, however, need not be seen as limiting in any way.

The insert 120 may be substantially cylindrically shaped to complement the accommodation of the bore 114. The insert 120 may include an outer contour that complements the bore 114 of the specimen 102. A placement of the insert 120 relative to the bore 114 may define a clearance 142 there between. The insert 120 may include an adapter-engaging portion 144, which may be inserted into the insert-receiving portion 136 to accomplish an assembly with the adapter 122. As with the engagement option discussed above, the insert 120 may also be threadably engaged with the adapter 122. Other engagement options may be contemplated. The insert 120 may also include an insert channel 146 that runs along axially within the insert 120 and along the axis 105, which facilitates fluid communication between the adapter channel 134 and the bore 114 into which the insert 120 enters during a test process.

The insert 120 is generally configured to decrease or minimize a volume of fluid required to fill the clearance 142. Notably, a relatively smaller clearance 142 may require a substantially lesser capacity pulsation, while a relatively larger clearance 142 may necessitate a generally higher fluid pulsation. A structure of the insert 120 may thus be contemplated for different test requirements, which may also depend upon the operational capabilities of related hydraulic pulsations. Accordingly, a test process may be performed with an exclusion of the insert 120 as well, if a corresponding hydraulic pulsation is generated equivalently to a required degree.

The cap 126 generally helps contain a failed specimen (specimen 102) so that the broken pieces of the specimen 102 are positively retrieved during tests. The cap 126 may be secured to the clamp 118 at the clamp outlet 140, substantially above and adjacent the specimen head 112. Moreover, the cap 126 restricts the specimen 102 from inadvertently ejecting the fixture 104 while being subject to the stresses of the associated test process. The cap 126 may also be threadably engaged with the clamp 118, as with other engagement options noted above. The cap 126 may also include a cap channel 148 that facilitates passage of a strain gauge test wire 150, referred to as a test wire 150, hereinafter.

The sleeve 124 may be mounted about the abutting interface 129 that exists between the upper face 128 and the shoulder portion 106 of the specimen 102. In so doing, the sleeve 124 may restrict radial movements of the specimen 102 relative to the fixture 104. To complement the shoulder portion's mounting to the upper face 128, the sleeve 124 may be cylindrically structured to suitably accommodate both the specimen 102 and the upper face 128 of the adapter 122, therein. The sleeve 124 may be threadably engaged with the adapter 122, although other known connections means may be envisioned.

The strain gauge 117 may be positioned to abut the undercut wall segment 116, as shown. The strain gauge 117 may sense the strain sustained by the undercut wall segment 116 in both an axial direction, A, and a hoop direction, D, during a test process. The strain gauge 117 may be removably mounted to the undercut wall segment 116 to allow multiple or differently configured strain gauge mountings. Thus, a positioning of the strain gauge 117 may be designed for easy removal and replacement to the undercut wall segment 116. The test wire 150 may in turn connect to the strain gauge 117, which is operably positioned relative to the undercut wall segment 116.

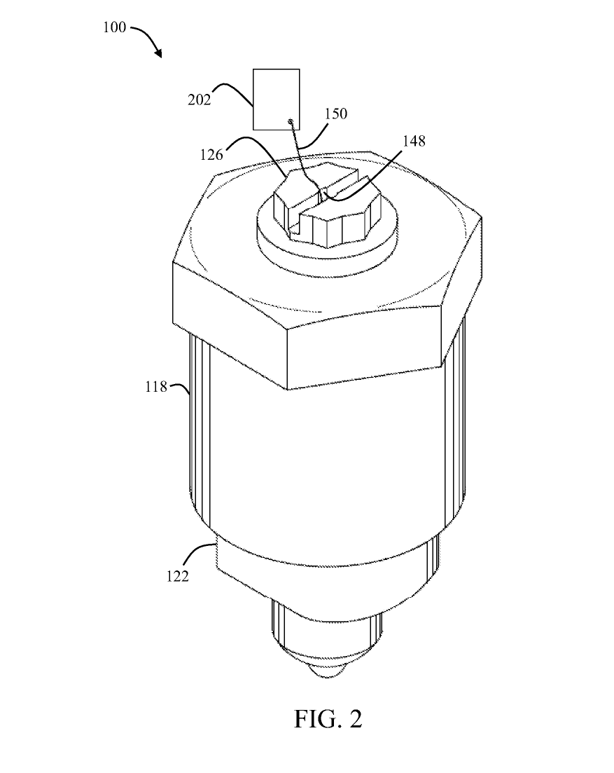

The test wire 150 may be selected from among the widely available test wires known in the art. The test wire 150 may be configured to conductively connect the undercut wall segment 116, via the strain gauge 117, as shown, to a data acquisition system 202 (shown in FIG. 2 for ease in understanding). In an embodiment, the test wire 150 may include a multiple lines that extend from the strain gauge 117 to facilitate measurement of stresses that act along multiple directions.

Referring to FIG. 2, there is shown a data acquisition system 202 connected by the test wire 150 to the specimen-fixture assembly 100 (see FIG. 1). Moreover, the substantial cylindrical profiles of the adapter 122, clamp 118 and the cap 126 may be visualized here.

The data acquisition system 202 may receive data and updates, as the specimen 102 (see FIG. 1) undergoes deformation, degradation, and/or physical changes, during the test process. Such responses may be registered by the strain gauge 117, which gauges the strain sustained by the undercut wall segment 116. Such data and updates may include a change in thickness, temperature, component property, state of strain in the undercut wall segment 116 (see FIG. 1), and/or the like. The data acquisition system 202 may include a memory where all such data is stored. The data acquisition system 202 may be configured to process the incoming data and generate related graphical charts, tabulations, and reports. In an embodiment, the request to initiate and close a testing process may be executed by the data acquisition system 202, as well.

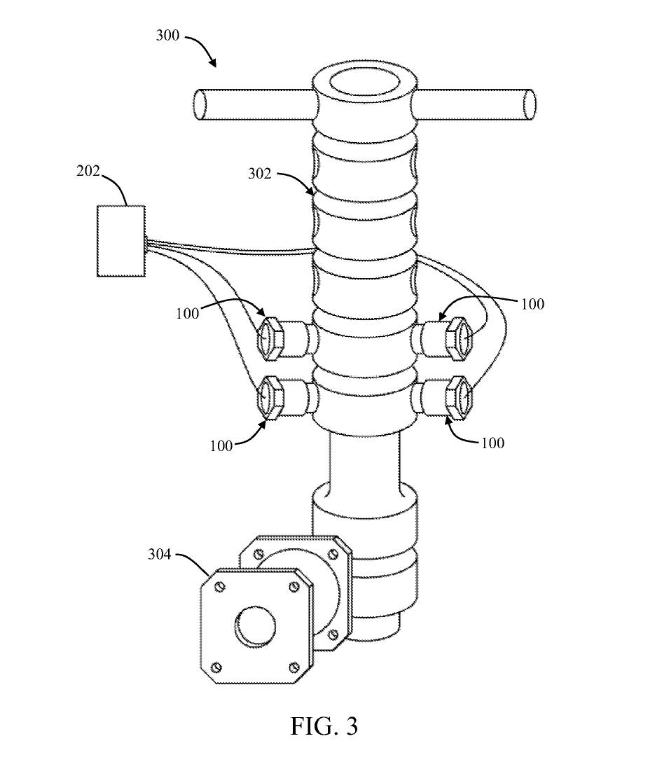

Referring to FIG. 3, a pressure-pulsated fatigue test system 300 is shown. The pressure-pulsated fatigue test system 300 may include a test equipment 302 and a hydraulic pulsation system 304. Although not limited, the test equipment 302 may include such as that manufactured by Maximator® GmbH. The test equipment 302 may include provisions for holding a plurality of pressure-pulsated fatigue test specimens (such as the specimen 102) within fixtures (such as the fixture 104).

The hydraulic pulsation system 304 is operably connected to the test equipment 302. The hydraulic pulsation system 304 may include a fluid, which, for example, may be a product of petroleum. The hydraulic pulsation system 304 may be configured to provide the clearance 142 with a volume of a pulsated fluid. A resultant generation of cyclic loading within the bore 114 of the specimen 102 may embody a periodic loading pattern. More specifically, the hydraulic pulsation system 304 may be configured to generate pressure between a first predetermined pressure and a second predetermined pressure at a predetermined frequency. Such a provision enables the bore 114 to be subject to a cyclic loading, thereby facilitating a fatigue test within the specimen 102.

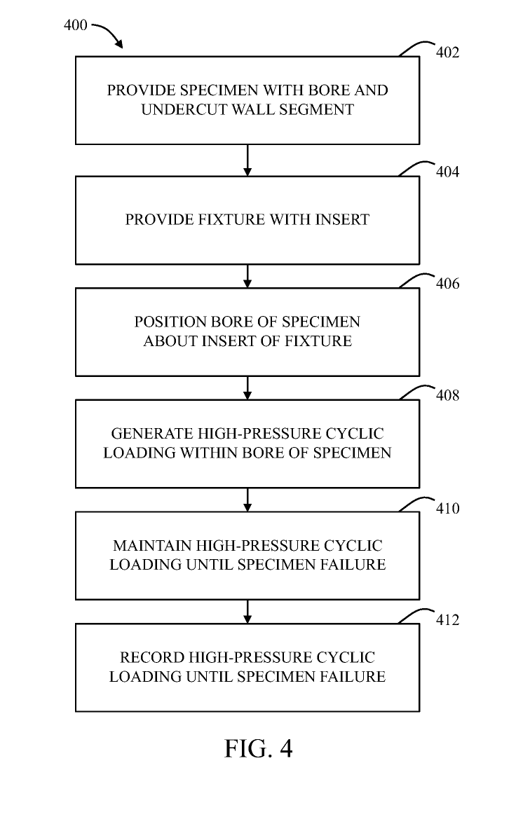

Referring to FIG. 4, a flowchart 400 shows the steps of an exemplary method in connection with the assembly and system discussed in FIGS. 1, 2 and 3. More particularly, the method describes an exemplary test of the specimen 102 according to the aspects of the present disclosure.

The method to test the specimen 102 initiates at step 402. At step 402, the specimen 102 is provided as the test sample. The specimen 102 includes the bore 114 and the undercut wall segment 116. The method proceeds to step 404.

At step 404, the fixture 104 is provided to retain the specimen 102. The fixture 104 includes the insert 120 and the clamp 118. The method proceeds to step 406.

At step 406, the bore 114 of specimen 102 is positioned substantially about the insert 120 of the fixture 104. Retaining the shoulder portion 106 of the specimen 102, by use of the clamp 118, in turn holds the specimen 102 to the fixture 104. The method proceeds to step 408.

At step 408, the hydraulic pulsation system 304 generates a cyclic loading within the bore 114 between a first predetermined pressure and a second predetermined pressure, at a predetermined frequency. The method proceeds to step 410.

At step 410, an ensuing cyclic loading is maintained until the specimen 102 fails. A failure of the specimen 102 may be understood by the fracture of the undercut wall segment 116. The method proceeds to end step 412.

At the end step 412, the data acquisition system 202 may record a plurality of cyclic loading to failure. In an embodiment, such records may be stored manually or by other known automated systems.

### INDUSTRIAL APPLICABILITY

In operation, the pressure-pulsated fatigue test system 300 may be carried out by establishing the specimen-fixture assembly 100. In an exemplary assembling process, an operator may initially affix the adapter 122 to the test equipment 302. As a variety of similarly applied components may require tests, a corresponding number of specimens (102) that vary in dimension and shape, may be engaged with the adapter 122. Therefore, the test equipment 302 may allow a plurality of specimen-fixture assembly 100 to be mounted thereof. Each fixture 104 within the specimen-fixture assembly 100 may facilitate mounting of a characteristic specimen, such as the specimen 102. Having the adapter 122 connected to the test equipment 302, the pressure-pulsated fatigue test system 300 may be operably and fluidly connected to the hydraulic pulsation system 304 to facilitate generation of cyclic pressure within the specimen 102.

Thereafter, the operator may couple the insert 120 to the adapter 122. An associated engagement may be threadably facilitated, as already discussed. Next, the specimen 102 may be brought into engagement with the insert 120. More particularly, the specimen 102 is mounted over the adapter 122 by accommodation of the bore 114 of the specimen 102 about the insert 120. The outer confines and contours of the insert 120 may readily complement the inner confines of the bore 114. A minimal clearance gap (clearance 142) is maintained between the bore 114 and the insert 120. One end of the test wire 150 may then be connected to the strain gauge 117, which is positioned at the undercut wall segment 116. Connection measures of the test wire 150 to the strain gauge 117 may be facilitated via soldering or brazing operations, or by other methods known in the art. In an embodiment, the strain gauge 117 may include an integrally connected test wire 150.

Once the specimen 102 is assembled to the adapter 122 and the test wire 150 connected to the undercut wall segment 116, the sleeve 124 may slidably engage the upper face 128 of the adapter 122. Other engagement means, such as a threadable engagement, may be contemplated. That engagement may in turn facilitate an abutting accommodation of the specimen 102, which is mounted flush about the circumference of the adapter 122, as shown and disclosed in FIG. 1. Next, the clamp 118 is engaged to the adapter 122 by engagement of the shoulder portion 106 of the specimen 102, thereby fixedly retaining the specimen 102 within the assembled fixture 104. As the clamp 118 is engaged, the other end of the test wire 150 may be drawn out of the clamp 118 through the clamp outlet 140. Subsequently, the cap 126 is brought into threadable engagement with the assembled fixture 104. The test wire 150 is then drawn out through the cap channel 148 as well, eventually having the other end of the test wire 150 extend out of the fixture 104. The other end of the test wire 150 may then be connected to the data acquisition system 202. Thereafter, the data acquisition system 202 may initiate monitor of reactions of the undercut wall segment 116 when subject to the cyclic loading generated by the hydraulic pulsation system 304.

An associated fluid line (not shown) of the hydraulic pulsation system 304 may be connected to the test equipment 302 via known means. As a result, a fluid communication is established between the hydraulic pulsation system 304 and each of the specimen-fixture assembly (100). The hydraulic pulsation system 304 then generates a cyclic loading within the bore 114 between a first predetermined pressure and a second predetermined pressure, at a predetermined frequency. An associated hydraulic fluid may first enter through the adapter 122, in the travel direction, A via the adapter channel 134. Thereafter, the hydraulic fluid may proceed to enter the insert-receiving portion 136, and flow through the insert channel 146, to eventually fill the clearance 142 that exists between the specimen 102 and the bore 114. As the hydraulic fluid is subject to a periodic pulsation process, cyclic loading is executed along the direction, B and C, as shown in FIG. 1. A consequent phenomenon may include the creation of a biaxial state of stress in both the relative hoop (direction, D) and the axial direction (direction A). Moreover, each cyclic loading event may be recorded until the specimen 102 fails by sustaining a fracture at the undercut wall segment 116. Such records may be stored, for example in the data acquisition system 202, for future retrieval.

The insert 120 minimizes a “dead” hydraulic volume in a related pulsation circuit, thereby increasing an apparent stiffness in a hydraulic flow. In so doing, the test process can be operated at higher operating frequencies, and/or with more specimens (specimen 102) simultaneously for a given hydraulic power capacity. This may ensure timely and considerably inexpensive tests.

It should be understood that the above description is intended for illustrative purposes only and is not intended to limit the scope of the present disclosure in any way. Thus, those skilled in the art will appreciate that other aspects of the disclosure may be obtained from a study of the drawings, the disclosure, and the appended claim.

What is claimed is:

1. A method for testing for fatigue in a test sample, the method comprising:
providing a specimen as the test sample, the specimen including, a shoulder portion, a tubular sidewall defining a bore, the tubular sidewall including an undercut wall segment, the tubular sidewall having a first thickness and the undercut wall segment having a second thickness, wherein the first thickness is greater than the second thickness;
providing a fixture configured to retain the specimen that includes an insert and a clamp;
positioning the bore of the specimen substantially about the insert and retaining the shoulder portion of the specimen by using the clamp;
generating a cyclic loading within the bore by hydraulic pulsation between a first predetermined pressure and a second predetermined pressure at a predetermined frequency;
maintaining the cyclic loading until the specimen fails by a fracture of the undercut wall segment; and
recording a plurality of cyclic loading to failure.
